(19) United States
(12) Patent Application Publication
(10) Pub. No.: US 2007/0019274 A1
(43) Pub. Date: Jan. 25, 2007

(54) Double pass light modulator

(76) Inventors: Scott Lerner, Corvallis, OR (US); John R. Sterner, Albany, OR (US); Arthur R. Piehl, Corvallis, OR (US); Anurag Gupta, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/188,330

(22) Filed: Jul. 25, 2005

(51) Int. Cl. G02F 1/03

(52) U.S. Cl. 359/245

(57) ABSTRACT

An embodiment of a double pass modulator includes a reflective polarizer adapted to pass light having a predetermined polarization state therethrough and to reflect substantially all other light, a quarter wave plate positioned to receive and pass light from the reflective polarizer, the quarter wave plate shifting the relative phase of the light passing therethrough by 45° with respect to the optic axis of the plate, and a reflector that receives light from the quarter wave plate and modulates at least a portion of the light incident thereon in a predetermined manner.

### TECHNICAL FIELD OF THE INVENTION

The present invention relates to light modulators used to improve contrast and/or resolution of selected characteristics of reflected light.

### BACKGROUND

Reducing cost and complexity of optical devices while improving their performance is an overarching goal of the display industry. Heretofore, multiple such devices have been used to modulate or otherwise condition incident light to improve such characteristics as contrast and the like. But, as will be appreciated, the use of multiple optical devices in a series is expensive, complicated, and can introduce artifacts into the modulated light resulting from defects in one or more of the optical devices.

### DESCRIPTION OF THE DRAWINGS

FIG. 1 is a schematic view of one embodiment of a double pass modulator as used in an embodiment of a display.

FIG. 1A is a block diagram illustrating an embodiment of a projection system, according to another embodiment of the present invention.

FIG. 2 is a schematic close up of one embodiment of a double pass modulator showing the path of light incident thereon.

FIG. 3 is a diagram of one embodiment of a double pass modulator for at least partially displaying a pixel of an image.

### DETAILED DESCRIPTION

In the following detailed description of the invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

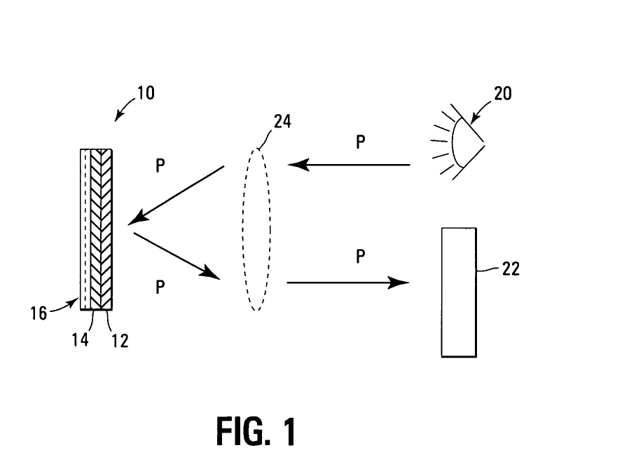

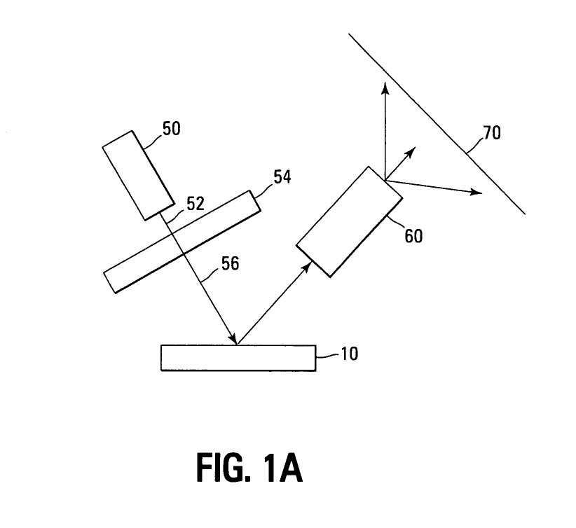

Turning first to FIG. 1, one embodiment of a double pass modulator 10 as employed as part of a display or projection system can be seen. Such a projection system may include, among other things, an illumination relay 20 that projects light onto the modulator 10, and a target 22, to which light emitted from the modulator 10 is directed. In some embodiments, one or more other optical devices 24 such as a lens, a prism, or the like, represented schematically in phantom lines in FIG. 1, may be interposed between the illumination relay 20 and/or the target 22 and the modulator 10. In other embodiments, no such optical devices are interposed between the illumination relay 20 and/or the target 22 and the modulator 10.

In some embodiments, the modulator 10 is adapted to selectively reflect light from the illumination relay 20 to the target 22, i.e. the modulator 10 will in some instances operate in a binary manner. When operating in a binary manner, the modulator 10 will, in a first, on-state, reflect or emit substantially all the light incident thereon. In a second, off-state, the modulator 10 will absorb, pass, or otherwise prevent substantially all light from being emitted or reflected therefrom onto the target 22. In other embodiments, the modulator 10 may operate in a continuous manner in which a selected portion of the light incident thereon is ultimately directed to the target 22, i.e. the intensity of the light emitted from the modulator 10 may be continuously modified. In yet other embodiments, light incident on the modulator is filtered such that only light within a predetermined range of wavelengths is emitted therefrom. In the filtering embodiments, the modulator 10 may be operated in a binary manner in which the modulator 10 selectively emits or absorbs light within the predetermined range of wavelengths or in a continuous manner in which the predetermined range of wavelengths emitted by the modulator are shifted or modified up and down the optical spectrum. It is to be understood that the modulator 10 may also be operated in a combination of binary and continuous manners in that, by way of example only, the intensity of light and the range of wavelengths emitted from the modulator 10 may be continuously modified and selectively turned on and off as need be.

FIG. 1a is a block diagram illustrating a projection system employing a double-pass modulator, according to another embodiment. In operation, an illumination system 50, e.g. a lamp, emits a light beam 52. Light beam 52 passes through a polarization converter 54 that converts light beam 52 into a light beam 56 having a single polarization. Light beam 56 is reflected off the modulator 10, as described above and as described further below, and is passed through a projection lens 60. Projection lens 60 directs the light onto a target (or screen) 70.

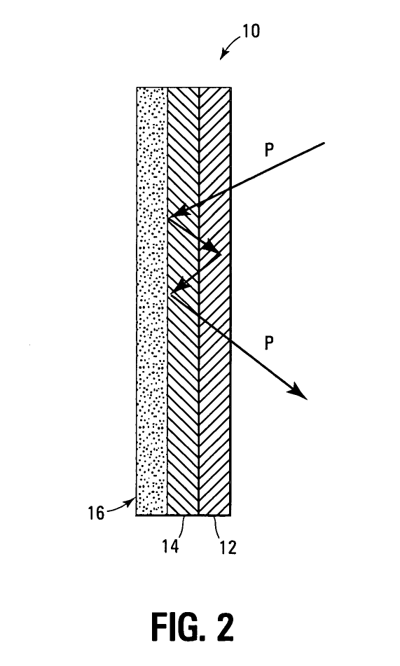

Referring next to FIG. 2, the modulator 10 may be seen to comprise a reflective polarizer 12, a quarter wave plate 14 and a reflector 16. As used herein, the term reflector 16 encompasses wholly or partially reflective mirrors and silvered surfaces, etalons and/or interferometers and any other device or structure that is at least partially reflective. Taken together, the reflective polarizer 12 and quarter wave plate 14 used in conjunction with the reflector 16 ensure that light incident upon the modulator 10 is conditioned or modulated twice before being emitted/reflected therefrom. Note that the modulator 10 may be constructed as a monolithic structure wherein the reflective polarizer 12, the quarter wave plate 14 and the reflector 16 are all in direct contact with one another. In one embodiment, the reflective polarizer 12, the quarter wave plate 14 and the reflector 16 may all be formed as thin films or plates that are laminated to form a single, monolithic structure. In other embodiments, the reflective polarizer 12, the quarter wave plate 14 and the reflector 16 may be separate structures that are spaced apart from one another.

The reflective polarizer 12 is adapted to pass light having a predetermined polarization state P and to reflect light having other polarization states. Accordingly, only light having the polarization state P is passed therethrough. Most or substantially all other light is reflected from the reflective polarizer 12. In one embodiment of modulator 10, a suitable reflective polarizer 12 is a film produced by 3M of St. Paul, Minn.

Upon passing through the reflective polarizer 12, the polarized light passes through a quarter wave plate 14. The quarter wave plate is aligned in such a manner that its optical axis is at an angle with respect to the direction of polarization. The quarter wave plate 14 modifies or shifts the relative phase of the two components of incident polarization along and perpendicular to the optical axis of the quarter wave plate by 90°.

After passing through the quarter wave plate 14, the phase-shifted polarized light (which no longer has its original polarization state P) is incident upon the reflector 16. Depending on how the reflector 16 is configured, the reflector 16 will reflect a predetermined portion of the light incident thereon. The reflector can be any optical modulator such as LCD, LCOS, DMD, etc.

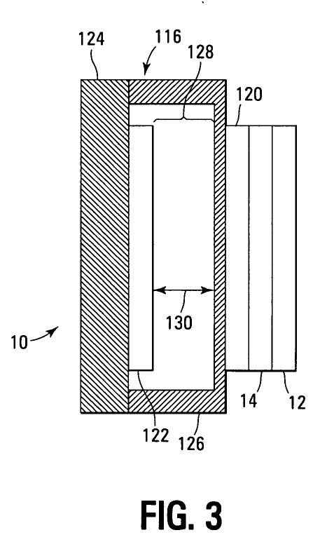

In one embodiment, the reflector is an interferometer of the type described in U.S. patent application Ser. No. 20040218251 A1, filed on Apr. 30, 2003, assigned jointly herewith and hereby incorporated by reference. This embodiment, illustrated in FIG. 3, is of a modulator 10 having a reflector 116 useful in displaying at least a portion of a pixel of an image. It is to be understood that in some embodiments, multiple modulators 10 may be ganged to form a single pixel. The reflector 116 encompasses a micro-electromechanical actuator having a top reflector 120 and a bottom reflector 122, a flexure 124 and a spring mechanism 126. The reflectors 120 and 122 define a resonant optical cavity 128 having a variable thickness 130. The top reflector 120 is in one embodiment semi-transparent; that is, the bottom reflector 122 is in one embodiment semi-reflective. The spring mechanism 126 is in some embodiments a flexible material such as a polymer that having a linear or non-linear spring functionality. The spring mechanism 126 couples the flexure 124 having the bottom reflector 122 secured thereon to the top reflector 120 and enables relative motion between the two reflectors.

The optical cavity 128 is variably selective of a visible wavelength by means of optical interference. Depending on the desired configuration of the reflector 116, the optical cavity 128 may either reflect or transmit a chosen wavelength, i.e. the cavity 128 may be either reflective or transmissive in nature. No light is generated by the cavity 128. The wavelength and the intensity of light reflected by the reflector 116 are dependent on the thickness 130 of the cavity 128 as the magnitude of interference to which light incident upon the reflector 116 is subjected is directly related to the thickness 130 of the cavity 128. The interference engendered by the cavity 128 permits the ready selection of particular wavelengths and light intensities.

Light reflected from the reflector 16 or 116 of the modulator 10 passes again through the quarter wave plate 14, which again shifts the relative phase of the light passing therethrough by a quarter of a wavelength or 90° with respect to the optic axis of the plate. As the phase of this light is now shifted by 180° from its original P polarization state, the light is substantially reflected from the reflective polarizer 12 and passes once more through the quarter wave plate 14, where it is again relative phase-shifted by one quarter of a wavelength or 90°. The light is then incident a second time upon the reflector 16 or 116, which modulates the light as described in conjunction with FIG. 3. Note that where optical devices other than an interferometer is chosen as the reflector 16, light incident thereon will be modulated in a manner consistent with the functionality of the chosen optical device.

Light reflected from the reflector 16 or 116 on this second pass, if any, passes through the quarter wave plate 14 yet again, and in doing so, is relative phase-shifted another quarter of a wavelength or 45°. Because the light will have passed through the quarter wave plate 14 four (4) times, it will have been relative phase shifted a full 360° and accordingly will again have the same polarization state P that it had upon passing through the reflective polarizer 12. The light, now again having a polarization state P, will pass through the reflective polarizer 12 and out of the modulator 10. At this point, the light will have been modulated twice by a single modulator 10. Because modulation of the light has taken place in a single device, and because the reflector 16 may be chosen or adapted to minimize the reduction in intensity of the light incident thereon, the use of a single, double pass modulator to modify or otherwise condition light will result in an improved contrast ratio that, in some embodiments, can be readily controlled. Since the thickness of polarization and quarter wave plate layers are relatively small, the rays will not be displaced from one pixel to another during the double pass.

### CONCLUSION

Although specific embodiments of a double pass modulator have been illustrated and described herein, it is manifestly intended that this invention be limited only by the following claims and equivalents thereof.

What is claimed is:

1. A double pass modulator comprising:
a reflective polarizer adapted to pass light having a predetermined polarization state therethrough and to reflect substantially all other light;
a quarter wave plate positioned to receive and pass light from the reflective polarizer, the quarter wave plate shifting the relative phase of the light passing therethrough by 45° with respect to the optic axis of the plate; and
a reflector that receives light from the quarter wave plate and modulates at least a portion of the light incident thereon in a predetermined manner.

2. The double pass modulator of claim 1 wherein light passed through the reflective polarizer is incident upon the reflector at least twice before being emitted from the double pass modulator.

3. The double pass modulator of claim 1 wherein the reflector modulates light incident thereon in a manner chosen from a group consisting of: absorbing incident light, reflecting incident light towards a target, reflecting incident light away from a target, reflecting incident light of a predetermined range of wavelengths, passing light through the reflector and absorbing incident light within a predetermined range of wavelengths.

4. The double pass modulator of claim 1 wherein the reflector is chosen from a group consisting of an etalon, a partially reflective mirror and an interferometer.

5. The double pass modulator of claim 1 wherein the reflector comprises a micro-electromechancial actuator.

6. The double pass modulator of claim 5 wherein the micro-electromechanical actuator comprises a top reflector positioned in a fixed relationship with the quarter wave plate, a bottom reflector secured to a flexure, the flexure being coupled to the top reflector by a spring mechanism that is adapted to allow the flexure and the bottom reflector secured thereto to move in relation to the top reflector.

7. The double pass modulator of claim 1 wherein the reflecting polarizer and the quarter wave plate are in direct contact with one another.

8. The double pass modulator of claim 6 wherein the reflecting polarizer, the quarter wave plate and the top reflector are in direct contact with one another.

9. The double pass modulator of claim 1 wherein the reflecting polarizer, the quarter wave plate, and the reflector are all thin film structures.

10. The double pass modulator of claim 9 wherein the reflecting polarizer, the quarter wave plate, and the reflector are formed into a monolithic, multilayered modulator.

11. The double pass modulator of claim 1 wherein the reflecting polarizer, the quarter wave plate, and the reflector are distinct structures separated spatially from one another.

12. The double pass modulator of claim 7 wherein the reflector is in direct contact with the quarter wave plate.

13. The double pass modulator of claim 1 further comprising a light source that emits light onto the double pass modulator.

14. The double pass modulator of claim 13 further comprising an optical device chosen from a group consisting of a lens and a prism interposed between the light source and the double pass modulator.

15. The double pass modulator of claim 1 further comprising a target upon which light emitted from the double pass modulator is incident.

16. The double pass modulator of claim 15 further comprising an optical device chosen from a group consisting of a lens and a prism interposed between the target and the double pass modulator.

17. The double pass modulator of claim 1 wherein the double pass modulator is one of an array of double pass modulators that comprises a display.

18. A double pass encoder comprising a polarizing reflector, a quarter wave plate and a reflecting means wherein at least the polarizing reflector and quarter wave plate are in substantially full facial contact with one another, the polarizing reflector and quarter wave plate being adapted to direct light onto the reflecting means twice.

19. The double pass encoder of claim 18 wherein the reflecting means is in substantially full facial contact with the quarter wave plate.

20. The double pass encoder of claim 18 wherein the reflecting means is selected from one of an etalon, an interferometer, and a partially transmissive mirror.

21. The double pass encoder of claim 18 wherein the reflecting means further comprises a micro-electromechanical system.

22. The double pass encoder of claim 18 wherein the double pass encoder is one of an array of double pass encoders.

23. The double pass encoder of claim 22 wherein the array of double pass encoders forms a display.

24. A display comprising:
an array of double pass modulators comprising:
a reflecting polarizer adapted to pass light having a predetermined polarization state therethrough and to reflect substantially all other light;
a quarter wave plate positioned to receive light from the reflecting polarizer and to pass this light therethrough, the quarter wave plate shifting the relative phase of the light passing therethrough by 45°;
an optical reflector that receives light from the quarter wave plate and reflects at least a portion of the light in a predetermined manner, the light being incident upon the optical reflector twice before being emitted from the double pass modulator.

25. A method of modulating light comprising:
filtering light through a reflective polarizer such that light having a predetermined polarization state P is passed through the reflective polarizer and substantially all other light is reflected therefrom;
relative phase shifting light filtered through the reflective polarizer a first time by one quarter of a wavelength by passing the light through a quarter wave plate; and
reflecting substantially only light having a predetermined optical characteristic.

26. The method of claim 25, further comprising relative phase shifting the reflected light a second time by one quarter of a wavelength by passing the light through a quarter wave plate.

27. The method of claim 26, further comprising reflecting substantially all of the twice relative phase-shifted light from the reflective polarizer.

28. The method of claim 27, further comprising relative phase shifting the reflected light a third time by one quarter of a wavelength by passing the light through a quarter wave plate.

29. The method of claim 28, further comprising reflecting substantially only light having a predetermined optical characteristic.

30. The method of claim 28, further comprising relative phase shifting the reflected light a fourth time by one quarter of a wavelength by passing the light through a quarter wave plate to return the light to a predetermined polarization state P.

31. The method of claim 29, further comprising emitting modulated light through the reflective polarizer.

32. A double pass modulator comprising:
means for passing light having a predetermined polarization state and to reflecting substantially all other light;
means for relative phase shifting the light passed by the light passing and reflecting means by one quarter of a wavelength; and
means for reflecting substantially only phase-shifted light from the relative phase shifting means having a predetermined optical characteristic.
